(19) United States
(12) Patent Application Publication
(10) Pub. No.: US 2011/0139570 A1
(43) Pub. Date: Jun. 16, 2011

(54) DEVICE FOR MECHANICALLY DISENGAGING AN AUTOMATICALLY ENGAGED CLUTCH DEVICE

(75) Inventor: Christian KUNZE, Gross-Gerau (DE)

(73) Assignee: GM GLOBAL TECHNOLOGY OPERATIONS, INC., Detroit, MI (US)

(21) Appl. No.: 12/943,409

(22) Filed: Nov. 10, 2010

(30) Foreign Application Priority Data
Nov. 11, 2009 (DE) 102009052710.9

(51) Int. Cl. F16D 25/063; F16D 28/00

(52) U.S. Cl. 192/84.91; 192/85.63

(57) ABSTRACT

A device is provided for mechanically disengaging an automatically engaged clutch device. The clutch device has a hydraulic or electrical disengaging mechanism. The hydraulic disengaging mechanism has a disengaging lever that can be moved via a hydraulic disengaging cylinder and has a central disengaging bearing. The central disengaging bearing relieves a contact disk mechanically prestressed with a contact pressure upon activation of the hydraulic disengaging cylinder, and releases a clutch disk. An electrical disengaging mechanism works with clutch lamellae, which are released when a solenoid element is excited, and mechanically block a clutch disk with the solenoid element de-energized. An electrically operated hydraulic pump with electrically operated hydraulic valve or an electrically actuated solenoid element with electrically actuated coupling lamellae can automatically disengage an automatically engaged clutch device via the disengaging mechanism during automatic switching processes. A hydraulic supply line secured by a check valve is coupled to the electrical hydraulic pump or to the solenoid element, and connected with a manual hydraulic pump to release a blocked clutch disk.

### CROSS-REFERENCE TO RELATED APPLICATION

This application claims priority to German Patent Application No. 102009052710.9, filed Nov. 11, 2009, which is incorporated herein by reference in its entirety.

### TECHNICAL FIELD

The technical field relates to a device for mechanically disengaging an automatically engaged clutch device. The clutch device has a hydraulic or electrical disengaging mechanism. The hydraulic disengaging cylinder has a disengaging lever, which exhibits a central disengaging bearing and can be moved via a hydraulic disengaging cylinder. The disengaging bearing relieves a contact disk mechanically prestressed with a contact pressure upon activation of the hydraulic disengaging cylinder, and releases a clutch disk.

### BACKGROUND

An electrical disengaging mechanism operates together with clutch lamellae, which are released when a solenoid element is excited, and mechanically block a clutch disk with the solenoid element de-energized. An electrically operated hydraulic pump with electrically operated hydraulic valve or an electrically actuated solenoid element with electrically actuated clutch lamellae can automatically disengage an automatically engaged clutch device via the disengaging mechanism during automatic switching processes. However, when the disengaging mechanism is not actuated, the clutch disk is automatically blocked in such clutch devices.

The disadvantage to this is that the vehicle can neither be towed nor bump started in critical situations. In order to tow or bump start a vehicle, the vehicle must either be idling, or the clutch device must be disengaged, in particular if there is no release-free mechanism for the vehicle.

To illustrate the problem, FIG. 4 shows a double clutch gearbox 21 with six speeds, wherein FIG. 4 depicts the for the first speed, which with the vehicle idling is latched with the accompanying lamellae clutch 15. While the second lamellae clutch is not engaged with its clutch lamellae 19, the vehicle cannot be readily moved without damaging the gearbox or engine or clutch device.

For this reason, the vehicle axis connected with this two-clutch gearbox 21 via a differential must be jacked up during the towing process, so that simple towing with a second passenger vehicle having a tow bar or tow rope is practically impossible, unless the clutch disks 18 and 19 of both lamellae clutches 15 and 16 are not engaged with the two clutch disks 9 and 25. In order to realize the above, the clutch lamellae 18 of the lamellae clutch 15 shown here must release the blocked clutch disk 9 for the first speed.

FIG. 5 shows a hydraulically actuatable clutch device 2 with blocked or engaged clutch device 2, which has a hydraulic disengaging mechanism 4 in the clutch device 2 in a disengaging lever 6 that can be moved via a hydraulic disengaging cylinder 5. The disengaging lever on a disengaging bearing 7 here exerts a mechanical contact pressure on a prestressed contact disk 8 during activation of the hydraulic contact cylinder 5, and as depicted on FIG. 6, releases the clutch disk 9 given an automatically switched gearbox. However, with the hydraulic disengaging cylinder 5 under no pressure, as depicted on FIG. 5, and hence with the engine turned off, the clutch disk is blocked, so that the engine and gearbox remain automatically connected with the clutch disk, which entails the disadvantages mentioned above.

Known from publication DE 698 36 894 T2 is a device for engaging and disengaging a clutch, which encompasses a manual clutch disengaging/engaging means for disengaging and engaging a clutch after pressing/releasing a clutch pedal. In order to automatically disengage and engage the clutch, this device is equipped with a receiver for a specific signal. To this end, the known device has a switching controller to affect the switch between the manual disengaging/engaging of the clutch and automatic disengaging/engaging of the coupling, after the automatic engaging of the clutch has concluded. The switching controller is to make it impossible to switch between the manual disengaging/engaging of the clutch and automatic disengaging/engaging of the clutch if the clutch is not completely engaged.

As a consequence, this known clutch system presupposes that the vehicle has both a clutch pedal and an automatic clutch device with automatic oil pressure sensor, wherein a switch optionally allows the driver to use the food pedal or automatic oil pressure sensor to disengage the clutch. To this end, there is an electronic controller that releases or blocks the switch, depending on the operating mode of the vehicle.

The disadvantage to this known device for engaging and disengaging a clutch is that the electronic controller must also be ready for operation in an emergency to release the switch. Also disadvantageous is that, given a malfunction of the controller, the communicating oil pressure lines and a switching cylinder as well as an actuating cylinder must be filled with oil and ready for operation, so as to allow the clutch to engage and disengage via the clutch pedal even given a malfunction of the electronic controller. Another disadvantage to the known clutch system lies in the fact that lamellae clutches, which are electrically engaged and disengaged by solenoid elements, cannot be disengaged in an emergency using the clutch system known from DE 698 36 894 T2.

Known from publication DE 101 59 640 A1 is an emergency clutch device. To this end, an emergency operating method and emergency operating device is described for opening or closing an automatically actuatable start-up clutch of a motor vehicle. In normal operation, the start-up clutch is opened or closed by an actuating device that is electrically operated and activated, and in the event of a malfunction in the electrically operated or activated actuation device by an emergency operating device. The emergency operating device opens the start-up clutch when a drive engine speed limit is dipped below, while it closes the start-up clutch when the drive engine speed limit is exceeded. As a result, a behavior resembling a mechanical centrifugal clutch is achieved without an electrical or electronic control component during the emergency control of the start-up clutch.

The disadvantage to this emergency clutch device is that it presumes that the engine can be and is operated in every case, since only then are structural designs similar to the centrifugal clutch possible to achieve a limit where the emergency clutch device releases the clutch disk, enabling a smooth bump starting or towing of the vehicle. However, this precondition that the engine be in operation has the disadvantage that this emergency clutch device offers no way, given a total failure of the vehicle, of releasing the clutch disk for towing or bump starting purposes.

In view of the foregoing, at least object is to provide a device for mechanically disengaging an automatically engaged clutch device that makes it possible to manually disengage the clutch device, and hence release the clutch disk, given the failure of all systems. In addition, other objects, desirable features, and characteristics will become apparent from the subsequent summary and detailed description, and the appended claims, taken in conjunction with the accompanying drawings and this background.

### SUMMARY

This object is achieved with A first embodiment according to the invention provides a device for mechanically disengaging an automatically engaged clutch device, wherein a hydraulic disengaging mechanism in the clutch device interacts with a disengaging lever that has a central disengaging bearing and can be moved by means of a hydraulic disengaging cylinder. The central disengaging bearing relieves a contact disk mechanically prestressed with a contact pressure upon activation of the hydraulic disengaging cylinder. A clutch disk is released when the contact disk is relieved. In addition, the device has an electrically operated hydraulic pump and an electrically operated hydraulic valve, which automatically disengages an automatically engaged clutch device via the disengaging mechanism automatically during automatic switching processes.

However, the clutch disk is blocked with the clutch device not activated. In order to release this blocked clutch, the device has a manual hydraulic pump, which is coupled to a check valve-secured hydraulic supply line to the hydraulic pump. This makes it possible to advantageously use a simple, manually operated hydraulic pump to again release the automatically blocked clutch disk during a malfunction and emergency by having the manual hydraulic pump build up pressure in the hydraulic line for the electrical hydraulic pump by way of the check valve, thereby activating the hydraulic disengaging cylinder, which now disengages the prestressed contact disk from the clutch disk via the disengaging bearing.

A second embodiment according to the invention provides for a device for mechanically disengaging an automatically engaged clutch device, wherein the second device interacts with an electrically operated lamellae clutch. Such a lamellae clutch has clutch lamellae that are automatically disengaged by means of an electrically actuatable solenoid element during automatic switching processes. A hydraulic emergency disengaging mechanism has a disengaging lever that can be moved via a hydraulic cylinder, and disengages the de-energized, engaged clutch lamellae. To this end, the hydraulic cylinder is connected with a manual hydraulic pump for releasing a blocked clutch disk. This second embodiment of the invention resolves the problem of detaching the self-blocking lamellae clutches of an automatic gearbox after the fact with a hydraulic hand pump by mechanically separating the clutch lamellae to again release the corresponding blocked clutch disk. To this end, the manual hydraulic pump preferably has a hand-activated pump. Such a hand-activated manual pump can have a removable hydraulic pump lever, so that only this hand lever is to be used in a corresponding pump rod assembly in an emergency to actuate the manual hydraulic pump, thereby enabling a release of the clutch disk by actuating the hand lever. In principle, the manual hydraulic pump can also be a foot-actuated hydraulic pump.

In another embodiment of the invention, the manual hydraulic pump is connected with a hydraulic storage tank via a hydraulic port of the manual hydraulic pump. The advantage to this is that the hydraulic line to the hydraulic disengaging cylinder of a hydraulic clutch need not always be filled with hydraulic fluid, instead of which corresponding pumping motions via the check valve can be used to fill and feed the hydraulic line from the hydraulic storage tank in case of emergency.

In order to ensure that a high enough hydraulic pressure to release a clutch disk is established in the supply line, a prestressed check valve is arranged at the output of the hydraulic pump, and the manual hydraulic pump is connected with a hydraulic storage tank. In another embodiment of the invention, the manual hydraulic pump is arranged outside the passenger compartment, and accessible by way of an engine hood or trunk lid.

It is also provided that the hydraulic pump is connected by means of the check valve, an oil pressure line and a clutch element with a hydraulic supply line of a disengaging cylinder of an automatic clutch device that is disengaged under no pressure. As a result, the engine can be decoupled from the gearbox in all emergency situations with a few components by releasing the clutch disk through manual pumping.

### BRIEF DESCRIPTION OF THE DRAWINGS

The present invention will hereinafter be described in conjunction with the following drawing figures, wherein like numerals denote like elements, and:

FIG. 1 shows an elementary diagram of a device for mechanically disengaging an automatically engaged clutch device according to a first embodiment of the invention;

FIG. 2 shows an elementary diagram of the device according to FIG. 1 after actuating a manual hydraulic pump;

FIG. 3 shows an elementary diagram of a device for mechanically disengaging an automatically engaged clutch device according to a second embodiment of the invention;

FIG. 4 shows an elementary diagram of a double-clutch gearbox with latched first speed;

FIG. 5 shows an elementary diagram of a hydraulic clutch device according to prior art;

FIG. 6 shows an elementary diagram of the hydraulic clutch device according to FIG. 5 after the clutch device has been automatically disengaged.

### DETAILED DESCRIPTION

The following detailed description is merely exemplary in nature and is not intended to limit application and uses. Furthermore, there is no intention to be bound by any theory presented in the preceding background or summary or the following detailed description.

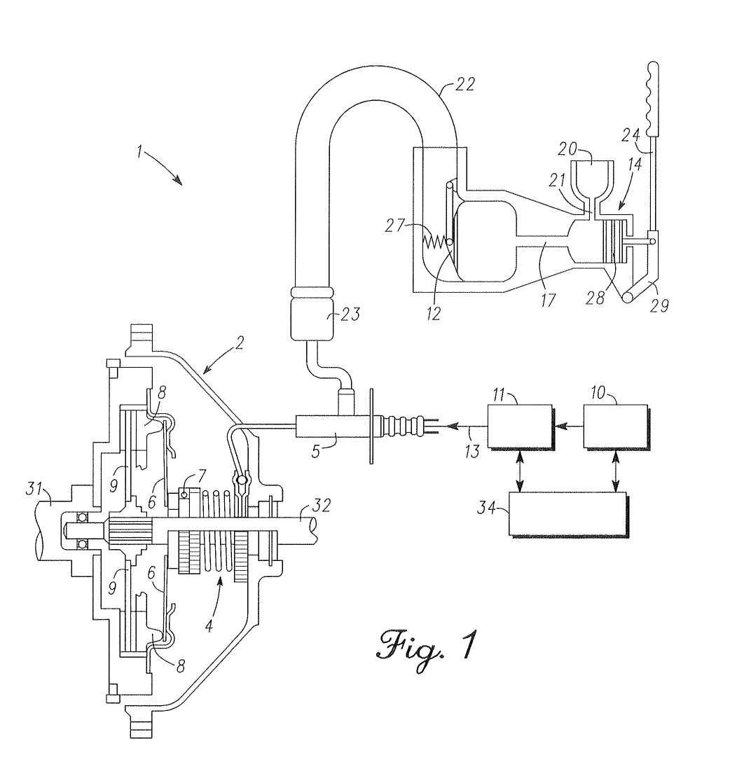

FIG. 1 shows an elementary diagram of a device 1 for mechanically disengaging an automatically engaged clutch device 2 according to a first embodiment of the invention. In order to disengage the hydraulic clutch device 2, the latter has a hydraulic disengaging mechanism 4, which is supplied by a disengaging cylinder 5 as the clutch device 2 automatically disengages with an elevated hydraulic pressure by way of a hydraulic supply line 13, an electrically actuatable hydraulic valve 11 and an electrically powered hydraulic pump 10. During the automatics witching of an automatic gearbox with the gear shaft 32, the clutch device 2 releases a clutch disk 9 arranged in the clutch device 2.

As a result, the clutch disk 9 is blocked with the clutch device 2 engaged in the case of a malfunction or emergency, so that the vehicle can only be towed or bump started with the gearbox coupled, which can damage the gearbox, engine or clutch during forcible towing. In order to still be able to actuate the disengaging mechanism 4 via the hydraulic disengaging cylinder 5, it is provided that a clutch element 23 be used to connect an oil pressure line 22, a manual hydraulic pump 14 with the disengaging cylinder. A check valve 12 prestressed with a spring element 27 is provided in the oil pressure line 22 at the output 17 of the manual hydraulic pump. The advantage to the above is that the oil pressure line 22 can also operate when dry if the manual hydraulic pump 14 has not been operational for a longer period of time.

Another advantage is that, when actuating the manual hydraulic pump 14, the hydraulic pump lever 24 can be used to pump hydraulic fluid into the oil pressure line 22 from a hydraulic storage tank 20 via a hydraulic port 21, without the hydraulic fluid flowing back into the hydraulic storage tank. the hydraulic pump lever 24 actuates a hydraulic piston 28 by means of a pump rod assembly 29, wherein the hydraulic pump lever 24 can be detached from the pump rod assembly 29. The manual hydraulic pump 14 can be accommodated in the engine compartment or trunk of a vehicle, since it is only actuated in an emergency, and can be stowed in a relatively compact and space-saving manner without a hydraulic pump lever 24 in the engine compartment or trunk of a vehicle.

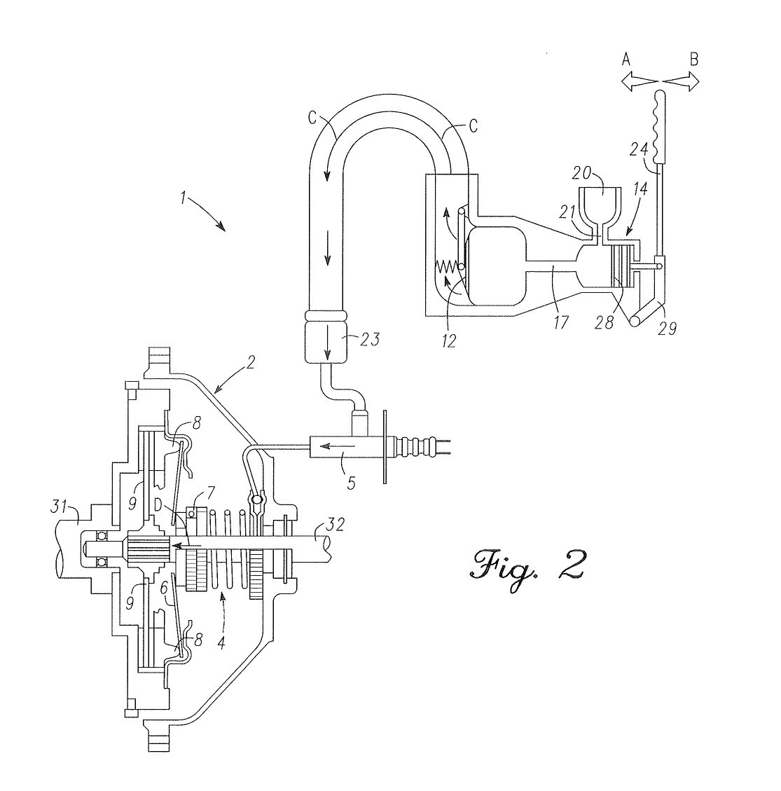

FIG. 2 shows an elementary diagram of the device 1 according to FIG. 1 after the manual hydraulic pump 14 has been actuated. The pumping motions in the direction of arrows A and B on the hydraulic pump lever 24 move the piston 28 via the pump rod assembly 29, and pumps hydraulic fluid from the hydraulic storage tank 20 to the check valve 12 via the hydraulic pump output 17, thereby building up a hydraulic pressure in the direction of arrow C that generates a corresponding disengaging pressure in the hydraulic disengaging cylinder 5, so that the hydraulic disengaging mechanism 4 moves a disengaging bearing 7 in the direction of arrow D, causing a disengaging lever 6 in the form of a disengaging disk to spring back a prestressed contact disk 8 that blocks the clutch disk 9 as depicted on FIG. 1, and releases the coupling disk 9, so that the engine shaft 31 is no longer engaged with the gear shaft 32 via the clutch disk 9. Such a disengaging device with a manual hydraulic pump 14 can also be provided for lamellae clutches if there is a suitable clutch element on hand for disengaging the lamellae.

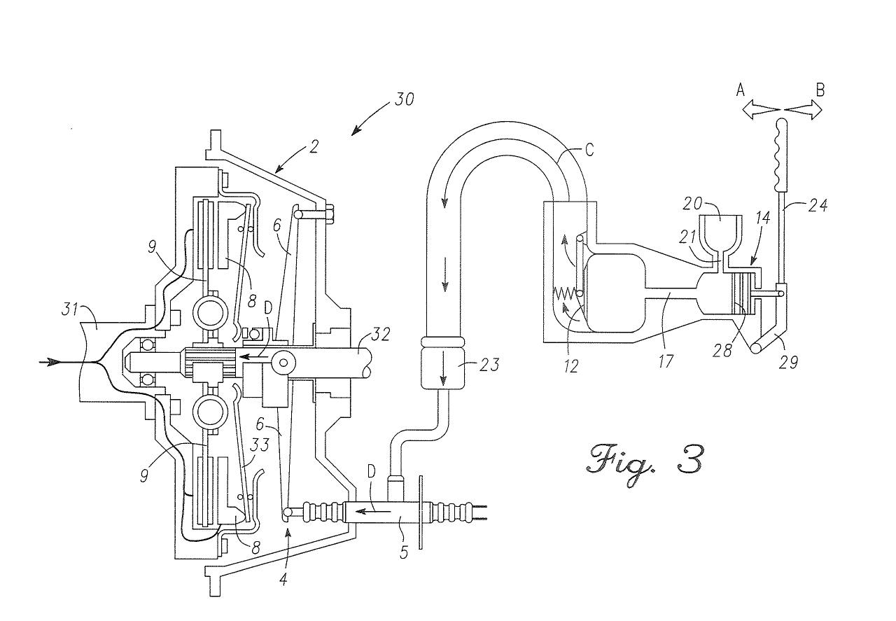

FIG. 3 shows an elementary diagram of a device 30 for mechanically disengaging an automatically engaged clutch device 30 according to a second embodiment of the invention. Components with the same functions as specified on FIGS. 1 and 2 are marked with the same reference numbers and not additionally described.

This case shows a state in which the manual hydraulic pump 14 is already in use and coupled with the disengaging cylinder 5, ensuring that a disengaging lever 6 in the clutch device 2 is moved in the direction of arrow D. A corresponding disengaging bearing 7 is also moved in the direction of arrow D by the lever action of the disengaging lever 5, so that a disengaging disk 33 releases a prestressed contact disk 8, as a result of which the clutch disk 9 is also released simultaneously, separating the engine shaft 31 and gear shaft 32 from each other.

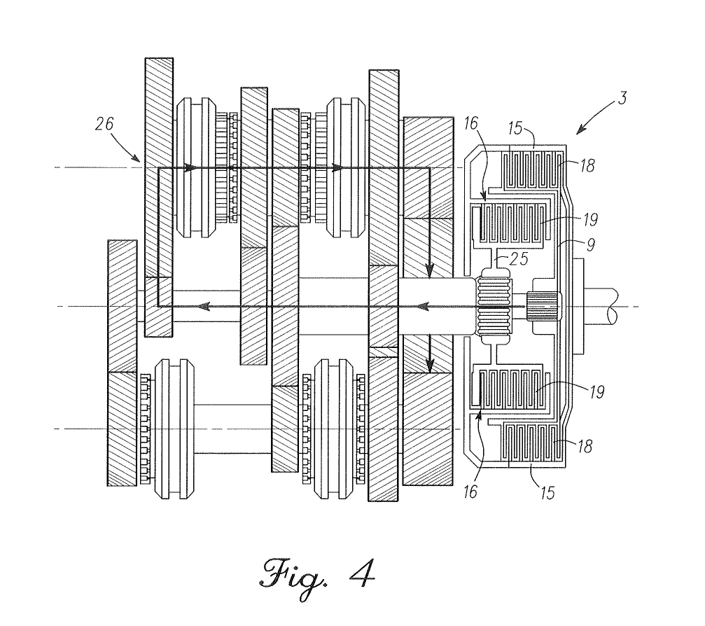

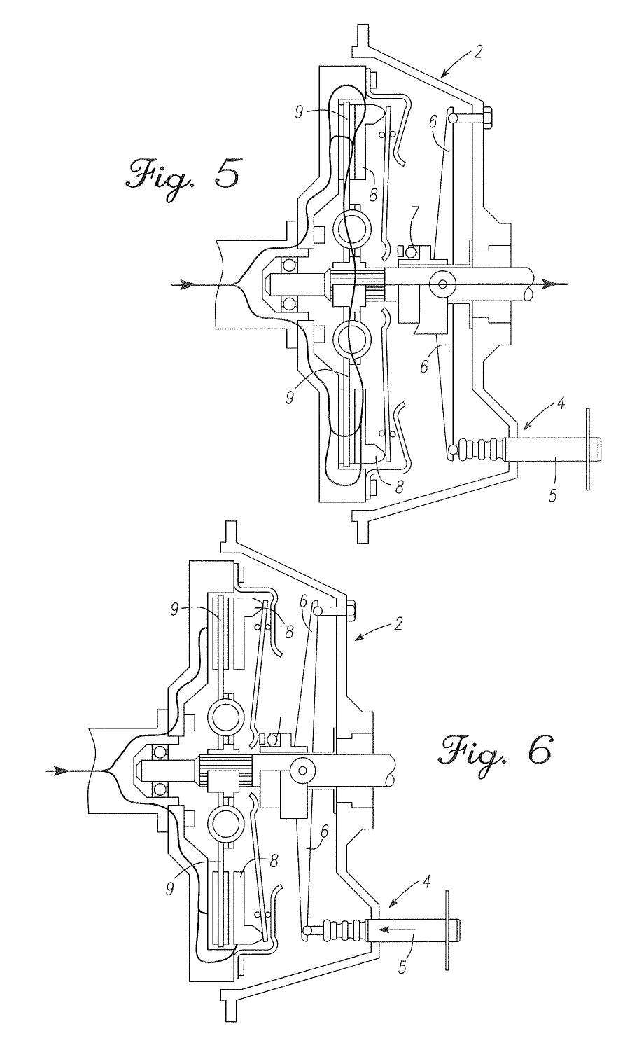

FIG. 4 to FIG. 6 show the gearboxes or clutch devices already described at the outset, which can be equipped with the device 1 and device 30 depicted on FIG. 1 to FIG. 3 for mechanically disengaging an automatically engaged clutch device 2 or 3 in emergency situations in order to manually disengage and release clutch disks 9 or 25.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A device for mechanically disengaging an automatically engaged clutch device, comprising:
a hydraulic disengaging mechanism in the automatically engaged clutch device; a disengaging lever of the hydraulic disengaging mechanism is adapted to move via a hydraulic disengaging cylinder;
a central disengaging bearing adapted to relieve a contact disk mechanically prestressed with a contact pressure upon activation of the hydraulic disengaging cylinder and release a clutch disk;
an electrically operated hydraulic pump and an electrically operated hydraulic valve that is adapted to automatically disengage the automatically engaged clutch device via the hydraulic disengaging mechanism during an automatic switching process; and
a hydraulic supply line secured by a check valve and coupled to the electrically operated hydraulic pump and connected with a manual hydraulic pump to release a blocked clutch disk.

2. The device of claim 1, wherein the manual hydraulic pump is a hand-activated pump.

3. The device of claim 1, wherein the manual hydraulic pump is a foot-activated pump.

4. The device of claim 1, wherein the electrically operated hydraulic pump is connected with a hydraulic storage tank via a hydraulic port of the manual hydraulic pump.

5. The device of claim 1, wherein a prestressed check valve is arranged at the output of the electrically operated hydraulic pump.

6. The device of claim 1, wherein the electrically operated hydraulic pump is arranged outside a passenger compartment and is accessible via an engine hood.

7. The device of claim 1, wherein the electrically operated hydraulic pump is arranged outside a passenger compartment and is accessible via a trunk lid.

8. The device of claim 1, wherein the electrically operated hydraulic pump is connected by the check valve, an oil pressure line, and a clutch element with the hydraulic supply line of a disengaging cylinder of an automatic clutch device that is disengaged under no pressure.

9. The device of claim 1, wherein the manual hydraulic pump comprises a removable hydraulic pump lever.

10. A device for mechanically disengaging an automatically engaged clutch device, comprising:
an electrically operated lamellae pump;
a clutch lamellae that is adapted to automatically disengage with an electrically actuatable solenoid element during an automatic switching processes; and
a hydraulic emergency disengaging mechanism comprising a disengaging lever that is adapted to move with a hydraulic cylinder and disengage the clutch lamellae,
wherein the hydraulic cylinder connected with a manual hydraulic pump adapted to release a blocked clutch disk.

11. The device of claim 10, wherein the manual hydraulic pump is a hand-activated pump.

12. The device of claim 10, wherein the manual hydraulic pump is a foot-activated pump.

13. The device of claim 10, wherein a electrically operated hydraulic pump is connected with a hydraulic storage tank via a hydraulic port of the manual hydraulic pump.

14. The device of claim 10, wherein a prestressed check valve is arranged at the output of an electrically operated hydraulic pump.

15. The device of claim 10, wherein an electrically operated hydraulic pump is arranged outside a passenger compartment and is accessible via an engine hood.

16. The device of claim 10, wherein an electrically operated hydraulic pump is arranged outside a passenger compartment and is accessible via a trunk lid.

17. The device of claim 10, wherein an electrically operated hydraulic pump is connected by a check valve, an oil pressure line, and a clutch element with a hydraulic supply line of a disengaging cylinder of an automatic clutch device that is disengaged under no pressure.

18. The device of claim 10, wherein the manual hydraulic pump comprises a removable hydraulic pump lever.
